(19) United States
(12) Patent Application Publication
(10) Pub. No.: US 2026/0078885 A1
(43) Pub. Date: Mar. 19, 2026

(54) TRANSMISSIVE OPTICAL COMPONENT, LIGHT MODULE FOR A MOTOR VEHICLE LIGHTING DEVICE AND METHOD FOR THE PRODUCTION OF THE OPTICAL COMPONENT

(71) Applicant: HELLA GmbH & Co. KGaA, Lippstadt (DE)

(72) Inventors: Christoph GEISTER, Lippstadt (DE); Odo KARGER, Geseke (DE)

(73) Assignee: HELLA GmbH & Co. KGaA, Lippstadt (DE)

(21) Appl. No.: 19/332,674

(22) Filed: Sep. 18, 2025

(30) Foreign Application Priority Data
Sep. 18, 2024 (DE) 10 2024 126 851.4

(51) Int. Cl. F21S 41/24; F21S 41/143

(52) U.S. Cl. CPC F21S 41/24; F21S 41/143

(57) ABSTRACT

A transmissive optical component, in particular a light guide or a lens, for a lighting system, in particular for a motor vehicle lighting device. The component comprises a component body having at least one light entry surface. A microstructured functional layer is arranged on the light entry surface, which has a synthetic resin, in particular a clear coat.

This nonprovisional application claims priority under 35 U.S. C. § 119(a) to German Patent Application No. 10 2024 126 851.4, which was filed in Germany on Sep. 18, 2024, and which is herein incorporated by reference.

### BACKGROUND OF THE INVENTION

### Field of the Invention

The present invention relates to a transmissive optical component for a lighting system, a method for its production, and a light module for a motor vehicle lighting device comprising such an optical component.

### Description of the Background Art

Transmissive optical components within the meaning of the present invention comprise a light-conducting and/or translucent component body with a light entry surface which is provided for irradiating light into the component body in an associated application. In particular, such an optical component can be designed as a light guide, for example as a fibrous light guide with light entry and light exit surfaces on the front side, or as a more complex light guide structure, such as a primary optic of a matrix LED headlight module. Furthermore, the transmissive optical component can be designed as a lens, for example.

In applications of such optical components in lighting systems, the highest possible efficiency in the coupling of light into the light entry surface is desired, wherein a major cause of efficiency losses lies in the (partial) reflection of light rays incident at flat angles. For reasons of space and cost, the associated illuminants are often not equipped with collimation optics, so that the light is emitted into comparatively large solid angle segments and thus in a correspondingly wide range of angles of incidence onto the light entry surface. In the case of high-performance illuminants, the generated operating heat or intense UV radiation can also lead to damage to optical components made of plastic, so that a safety distance must be maintained, which can cause further efficiency losses due to overexposure of the light entry surface.

### SUMMARY OF THE INVENTION

It is therefore an object of the present invention to provide a transmissive optical component for a lighting system which is specially designed for a high efficiency of light coupling and longevity.

The invention, in an example, discloses a transmissive optical component, in particular a light guide or a lens, for a lighting system, in particular for a motor vehicle lighting device, comprising a component body having at least one light entry surface on which a microstructured functional layer comprising a synthetic resin, in particular a clear coat, is arranged.

The invention is based on the idea of arranging microstructures made of a preferably transparent synthetic resin, in particular a clear coat, on the light entry surface, so that the light coupling into the optical component takes place via the surfaces of the microstructures. The microstructures are preferably shaped and arranged in such a way that a reduction of reflection losses for incident light is achieved. Furthermore, the microstructures can cause light to be bundled onto the light entry surface, i.e., the divergence angle of a light beam incident on the functional layer is reduced by appropriate refraction at the microstructures. For those purposes, the functional layer shall comprise, in particular, cone-shaped, jagged, rib-shaped, funnel-shaped or grooved microstructures, or combinations thereof. For example, the microstructures on the edge of the light entry surface may be shaped, arranged or dimensioned differently than on the central area.

The functional layer, for example, can have a layer thickness in the range of 5 μm to 100 μm. The microstructures of the functional layer can have characteristic dimensions in the micrometer range, approximately in the range of 1 μm to 50 μm.

Synthetic resins, also known as synthetic resins, are soft solids or highly viscous substances that commonly contain prepolymers with reactive functional groups. When processed, synthetic resins usually is formed of two main components, the mixture of which results in a reactive resin mass. A thermoset is formed as a product of the curing reaction. A clear coat to form the functional layer is preferably a solvent-free type of paint, which can be cured by radiation curing, in particular by irradiation with ultraviolet light (UV). Such paint types are based, for example, on binders made of reactive acrylates, epoxies, enol ethers or cyclic amines. Furthermore, excipients such as photo initiators or crosslinking agents may be included. The prerequisite for the use according to the invention is a high transparency of the cured clear coat for the light used in the respective application of the optical component, typically light from the visible spectrum.

Preferably, the synthetic resin of the functional layer has a higher heat resistance, a higher UV resistance and/or a higher hydrolysis resistance than the material of the component body, in particular than the material forming the light entry surface. This is particularly relevant in applications where the component body is made of a plastic, such as PMMA or polycarbonate. A more heat-and UV-resistant functional layer protects the underlying light entry surface from heat-or radiation-induced changes, such as cloudiness. In particular, a minimum distance to an assigned high-performance illuminant can be reduced without undesirable damage to the optical component due to waste heat during operation. This has the advantage of improved light efficiency, as overexposure of the light entry surface by the (non-collimated) light of the illuminant can be reduced or completely avoided. Furthermore, the functional layer serves as a protective layer of the component body against moisture and the associated hydrolysis processes.

The invention also relates to a light module for a motor vehicle lighting device, comprising at least one illuminant, in particular based on a light-emitting diode, and a transmissive optical component according to any one of the aforementioned examples, wherein the illuminant is arranged to the optical component in such a way that light emitted by the illuminant strikes the microstructured functional layer and is transmitted through the light entry surface into the component body.

For example, the light module can be designed for a daytime running light or rear light function and have an optical component in the form of an elongated light guide, the front side of which serves as the light entry surface, with the light being extracted via the lateral surface. In an example, the light module can be provided for a low beam and/or high beam function of a matrix LED headlight, wherein the optical component is designed as a light guide structure of a primary optic with a plurality of light entry surfaces, wherein the illuminant has a corresponding plurality of matrix-shaped light-emitting diodes. In particular, in the case of an optical component designed as a light guide, the distance between the comparatively heat-resistant functional layer and the illuminant can be as little as 0.2 mm to 1.5 mm.

The invention further relates to a method for the production of a transmissive optical component according to any one of the aforementioned examples, wherein the microstructured functional layer is produced by means of embossed lithography. The component body is provided, and the light entry surface is wetted with liquid or low-viscosity synthetic resin in the unhardened initial state. Then, a stamp with a negative of the desired microstructures is pressed into the applied synthetic resin, wherein the synthetic resin fills the negative due to its high fluidity. The synthetic resin is then cured so that the functional layer with the microstructures is formed, with the stamp being removed last.

The synthetic resin used to form the functional layer is preferably a UV-curable clear coat and the stamp used is transparent to UV light, so that the clear coat can be irradiated and cured through the stamp.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a sectional view of an example of a light module according to the invention,

FIG. 2 shows a detail of FIG. 1, and

FIG. 3 shows a side view of an example of a light module according to the invention.

### DETAILED DESCRIPTION

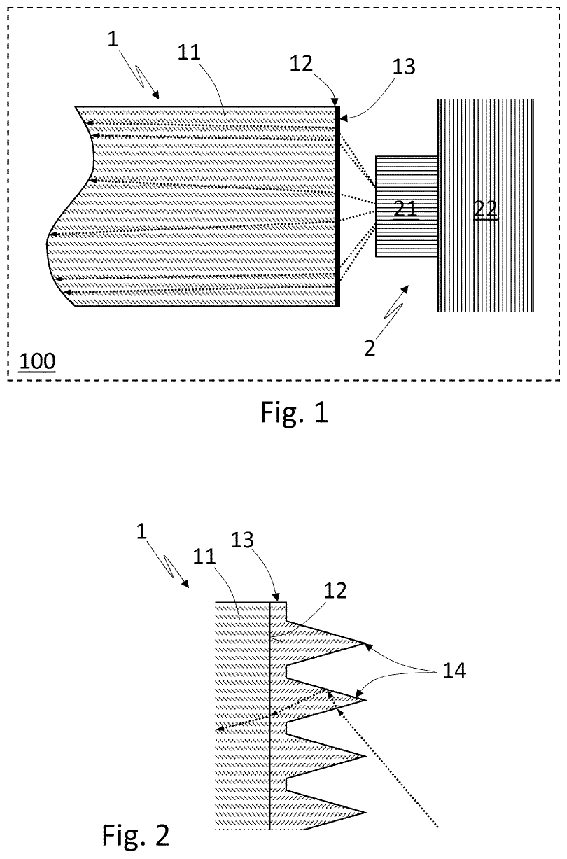

FIG. 1 shows a sectional view of a section of a light module 100 according to the invention with the transmissive optical component 1 in the form of a light guide and the illuminant 2, which comprises the light-emitting diode 21 on the circuit board 22. The flat frontal surface of the optical component 1 forms the light entry surface 12, and the illuminant 2 is arranged centrally in front of it. The light entry surface 12 is covered by the microstructured functional layer 13, so that the light emitted by the illuminant 2 (dotted arrows) hits the microstructured functional layer 13, couples into it and is subsequently transmitted through the light entry surface 12 into the light-conducting component body 11.

The microstructures of the functional layer 13 are shaped and arranged in such a way that a reduction of reflection losses for light irradiated by the illuminant 2 is achieved as well as a bundling of light on the light entry surface 12, so that the luminous efficacy of the light module 100 is improved. In addition, the clear coat that forms the functional layer 13 has increased resistance to the waste heat of the illuminant 2, so that it can be arranged at a particularly close distance, which prevents undesirable overexposure of the light entry surface 12.

FIG. 2 shows an enlarged detail of the optical component 1 according to FIG. 1. The microstructured functional layer 13 arranged on the light entry surface 12 has cone-shaped microstructures 14 in a regular arrangement. As can be seen from the illustration, the flanks of the microstructures 14 are suitable for absorbing incident light at a flat angle with the light entry surface 12 and transmitting it in the direction of the component body 11. For example, the height of the cone-shaped microstructures 14 as a characteristic dimension is 5 μm to 50 μm.

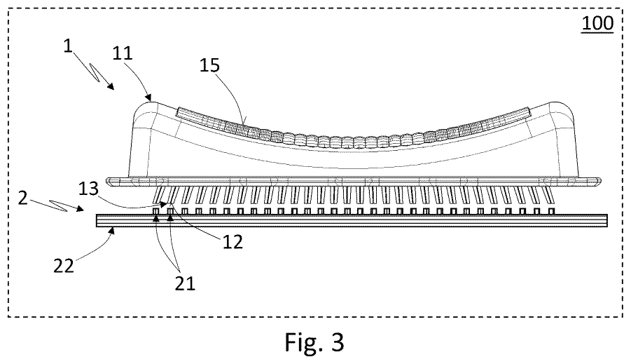

FIG. 3 shows a side view of a section of an example of the light module 100 for a matrix LED headlight according to the invention, wherein the optical component 1 is formed as a complex light guide structure of a primary optic with a plurality of light entry surfaces 12 and the illuminant 2 has a corresponding plurality of matrix-shaped light-emitting diodes 21.

The component body 11 is material-uniform and single-piece, for example made of a transparent silicone, and the light guide segments facing the light-emitting diodes 21 with the light entry surfaces 12 open at the front into the parceled light emitting surface 15. According to the invention, the microstructured functional layers 13 arranged on the light entry surfaces 12 of all light guide segments lead to a high luminous efficacy of the light module 100 due to the high light capture efficiency and the short distance to the light-emitting diodes 21.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A transmissive optical component for a lighting system for a motor vehicle lighting device, the transmissive optical component comprising:
a component body having at least one light entry surface;
a microstructured functional layer arranged on a light entry surface which has a synthetic resin or a clear coat.

2. The transmissive optical component according to claim 1, wherein the microstructures of the functional layer are shaped and arranged such to reduce reflection losses for incident light and/or to focus light on the light entry surface.

3. The transmissive optical component according to claim 1, wherein the functional layer has cone-shaped, jagged, rib-shaped, funnel-shaped or grooved microstructures.

4. The transmissive optical component according to claim 1, wherein the synthetic resin of the functional layer has a higher heat resistance, a higher UV resistance and/or a higher hydrolysis resistance than the material of the component body.

5. The transmissive optical component according to claim 1, wherein the functional layer has a layer thickness in the range of 5 μm to 100 μm.

6. A light module for a motor vehicle lighting device, the light module comprising:
an illuminant; and
the transmissive optical component according to claim 1,
wherein the illuminant is arranged to the optical component such that light emitted by the illuminant strikes the microstructured functional layer and is transmitted through the light entry surface into the component body.

7. The light module according to claim 6, wherein the illuminant is based on a light-emitting diode.

8. The light module according to claim 6, wherein the optical component is a light guide, and wherein a distance between the functional layer and the illuminant is 0.2 mm to 1.5 mm.

9. The light module according to claim 6, wherein the optical component is an optical fiber structure of a primary optic with a plurality of light entry surfaces, and wherein the illuminant has a corresponding plurality of light-emitting diodes arranged in a manner of a matrix.

10. A Method comprising:
providing the transmissive optical component according to claim 1; and
providing the microstructured functional layer via embossed lithography.

11. The method according to claim 10, wherein the functional layer is made of a UV-curable clear coat.

12. The transmissive optical component according to claim 1, wherein the transmissive optical component is a light guide or a lens.
